(19) United States
(12) Patent Application Publication
(10) Pub. No.: US 2011/0146866 A1
(43) Pub. Date: Jun. 23, 2011

(54) AUTOMATIC TIRE CHAIN SYSTEM

(76) Inventor: Samad Jafari Valilou, Tabriz (IR)

(21) Appl. No.: 12/819,205

(22) Filed: Jun. 20, 2010

Related U.S. Application Data
(60) Provisional application No. 61/288,272, filed on Dec. 19, 2009.

(51) Int. Cl. B60C 27/14

(52) U.S. Cl. 152/214

(57) ABSTRACT

The various embodiments of the present invention provide an automatic tire chain system for driving the vehicle on snowy roads. The automatic tire chain system includes a first cog wheel, a main cogwheel, a small cog wheel, an arm cog wheel, an electromagnetic motor, a plurality of chains connected to the arm cog wheel and a button. A pressing operation of the button provides for transferring a circular force to the main cog wheel thereby the first cog wheel transfers the circular force from the tire to the main cog wheel. Further the main cog wheel transfers the circular force to the arm cog wheel and the small cog wheel which in turn causes the plurality of chains either to open or get accumulated automatically.

### CLAIM PRIORITY

This patent application claims priority of U.S. Provisional Patent Application Ser. No. 61/288,272 filed Dec. 19, 2009, which is incorporated by reference in its entirety.

### SPONSORSHIP STATEMENT

The present invention is sponsored by Iranian National Science Foundation for international filing.

### BACKGROUND

1. Technical Field

The embodiments herein generally relate to wheels in automobiles and particularly to tire chains for wheels in vehicles moving in snowy roads. The embodiments herein more particularly relate to a system for operating the mechanic tire chain system in vehicles automatically.

2. Description of the Related Art

Often a driver riding a vehicle on snowy roads comes across various difficulties such as skidding of tires and overheating of engines. The snowy road increases the risk of skidding of the tires due to which the driver loses the control over the vehicle and causes an accident.

Presently the skidding of the tires on snowy roads is prevented by using tire chains or snowy chains. The tire chains are manually installed over the wheels of the vehicles. The tire chains installed provide an improved traction for vehicle wheels in snow and ice conditions. The tire chains are mounted around the outer perimeter of the tire. The friction between the tire chains and the road surface prevents the slippage of the wheels during rotation.

When the tire chains are installed over the wheels of the vehicle before moving on to the snowy roads, the speed of the vehicle decreases and damages the tire. Further, when the tire chains are not installed, the driver needs to search for a suitable place to stop and install the tire chains before moving on to the snowy roads.

Generally, the tire chains are manually installed over the wheels of the vehicle using woven fabric straps. The person installing the tire chains should have a required skill and experience to properly install the tire chains. The tire chains are tied around the wheel hub and the tire of the vehicles using the woven fabric straps.

The woven fabric straps used for tying the tire chains have several disadvantages. The woven fabric straps absorb water, freeze and become stiff and thick during use. As a result, the driver faces difficulty in removing the tire chains on normal roads. Moreover improper removal of tire chains from the vehicle wheels damages the woven fabric straps tied around the chains and may lose an attachment to the wheel and the tire.

Further, the driving on bare pavement with tire chains on the tires will lead to misdemeanor traffic violation. The tire chains installed over the wheels of the vehicles also cause mass imbalance of wheels and damages the vehicle when the tire chains are torn.

Hence there is a need to provide a system to install and wind up a tire chain in vehicles automatically during a ride on snow and icy roads.

The abovementioned shortcomings, disadvantages and problems are addressed herein and which will be understood by reading and studying the following specification.

### OBJECTS OF THE EMBODIMENTS

The primary object of the embodiments herein is to provide an automatic tire chain system for driving the vehicles on snowy roads.

Another object of the embodiments herein is to provide an automatic tire chain system that is operated automatically by pressing a single button.

Another object of the embodiments herein is to provide an automatic tire chain system which prevents mass imbalance of wheels.

Yet another object of the embodiments herein is to provide an automatic tire chain system which is independent of the operation of the vehicle.

Yet another object of the embodiments herein is to provide an automatic tire chain system which provides the flexibility to install the system in a plurality of vehicles by merely changing the dimension.

Yet another object of the embodiments herein is to provide an automatic tire chain system which requires reduced time and energy for installation.

Yet another object of the embodiments herein is to provide an automatic tire chain system which is safe and easy to operate even with a semi skilled personnel.

These and other objects and advantages of the present invention will become readily apparent from the following detailed description taken in conjunction with the accompanying drawings.

### SUMMARY

The various embodiments of the present invention provide an automatic tire chain system for driving the vehicle on snowy roads. The automatic tire chain system includes a first cog wheel, a main cogwheel, a small cog wheel, an arm cog wheel, an electromagnetic motor, a plurality of chains connected to the arm cog wheel and a button. A pressing operation of the button provides for transferring a circular force to the main cog wheel so that the first cog wheel transfers the circular force from the tire to the main cog wheel. Further the main cog wheel transfers the circular force to the arm cog wheel and the small cog wheel which in turn causes the plurality of chains to be opened or accumulated automatically.

The first cog wheel is arranged along a circular axis of an arm to transfer the circular force to the main cogwheel. The first cog wheel rotates around the main cog wheel when the automatic tire chain system is in a locked state.

The automatic tire chain system further includes a tumbler arm, a U shaped spring and one or more pins. The one or more pins are used to connect the plurality of chains to the first cog wheel. A pressing operation of the button drives the electromagnetic motor which causes the pin to exit the main cogwheel.

According to one embodiment of the present invention, a clamp plain is used to install the tire chain system on a vehicle. The main cog wheel includes at least one pin to operate the electromagnetic motor during chain functioning. The chain functioning includes installing the plurality of chains on the wheel or folding the chain.

The arm cog wheel is located on a stable axis and can rotate around its own circular axis in a semi circular fashion, when the chain is either in open condition or folded condition.

The small cog wheel is located on a stable axis and can rotate around its own circular axis through 180°, when the chain is either opened or accumulated.

The circular force from the wheel is transferred to the main cogwheel when the mechanism is in a free state and the flow of force to mechanism is interrupted.

According to one embodiment of the present invention, the plurality of tire chains sticks to the tire and rotates around the circular axis by throwing the tire chains under the tires due to centrifugal force.

According to one embodiment of the present invention, the first cog wheel rotates in a clockwise direction when the plurality of tire chains is opened. The main cogwheel and the small cog wheel rotate in an anti-clockwise direction which in turn causes the arm cog wheel to rotate in the clockwise direction when the tire chains are opened. The movement of the plurality of tire chains is stopped by releasing the button.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a side perspective view of the automatic tire chain system installed in the vehicles according to one embodiment.

FIG. 2 illustrates a side perspective view of the automatic tire chain system with the plurality of chains in an open condition according to one embodiment.

FIG. 3 illustrates a side perspective view of the automatic tire chain system with the plurality of chains in a folded condition according to one embodiment.

FIG. 4 illustrates an exploded view of the automatic tire chain system for vehicles according to one embodiment.

FIG. 5a-5b illustrates a schematic representation of the first cog wheel and the arm cog wheel in the automatic tire chain system according to one embodiment.

FIG. 6 illustrates a side perspective view of the automatic tire chain system with the plurality of chains opened over the tires according to one embodiment.

FIG. 7 illustrates a perspective view of the automatic tire chain system with the plurality of chains opened over the tires according to another embodiment.

Although the specific features of the embodiments herein are shown in some drawings and not in others. This is done for convenience only as each feature may be combined with any or all of the other features in accordance with the present invention.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments of herein provide an automatic tire chain system for driving the vehicle on snowy roads. The automatic tire chain system includes a first cog wheel, a main cogwheel, a small cog wheel, an arm cog wheel, an electromagnetic motor, a plurality of chains connected to the arm cog wheel and a button. A pressing operation of the button provides for transferring a circular force to the main cog wheel thereby the first cog wheel transfers the circular force from the tire to the main cog wheel. Further the main cog wheel transfers the circular force to the arm cog wheel and the small cog wheel which in turn causes the plurality of chains either to open or get accumulated automatically.

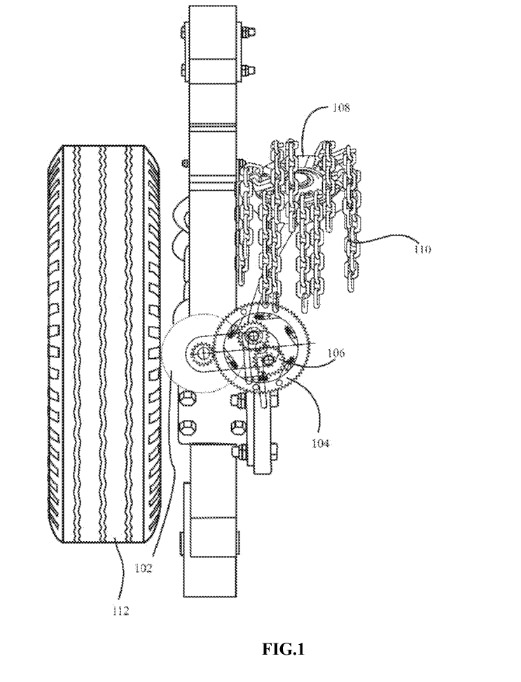

FIG. 1 illustrates a side perspective view of the automatic tire chain system for vehicles according to one embodiment. The automatic tire chain system includes a first cog wheel 102, a main cog wheel 104, a small cog wheel 106, an arm cog wheel 108, and a plurality of chains 110. The arm cogwheel 108 is in contact with the small cogwheel 106 and the main cog wheel 104 through the arm.

The automatic tire chain system is operated by pressing a button. The pressing operation of the button leads to transferring a circular force to the main cog wheel 104. The first cog wheel 102 transfers the circular force from the tire 112 to the main cog wheel 104 and the main cog wheel 104 transfers the circular force to the arm cog wheel 108 and the small cog wheel 106 which in turn causes the plurality of chains 110 either to open or get accumulated automatically.

The automatic chain tire system further includes an electromagnetic motor for starting the operation of automatic tire chains 112 when the button is pressed. The main cog wheel 104 includes at least one pin to operate the electromagnetic motor when the button is pressed. The pressing operation of the button stimulates the electromagnetic motor which causes the pin to exit the main cogwheel and the plurality of tire chains sticks to the tire and rotates around the circular axis by throwing the tire chains 110 under the tires 112.

The first cog wheel 102 is arranged along a circular axis of the arm to transfer the circular force to the main cogwheel 104. Further the first cog wheel 102 rotates around the main cog wheel 104 when the automatic tire chain system is in a locked state. The main cogwheel 104 rotates on a fixed axis in a particular direction and when the chain opens or accumulates, the pin for electromagnetic motor goes in the main cog wheel 104 and locks the automatic tire chain system.

The arm cog wheel 108 is located on a stable axis and rotates around its own circular axis half a round when the plurality of chains 110 is in either opened or accumulated mode. When the plurality of chains 110 is in the in open mode, the arm cog wheel 108 gets the force from the small cog wheel 106 for rotation and when the plurality of chains 110 is in the accumulated mode, the arm cog wheel 108 gets the force from the main cog wheel 104 for rotation. The small cog wheel 106 is located on a stable axis and rotates around its own circular axis half a round when the chain is either opened or folded.

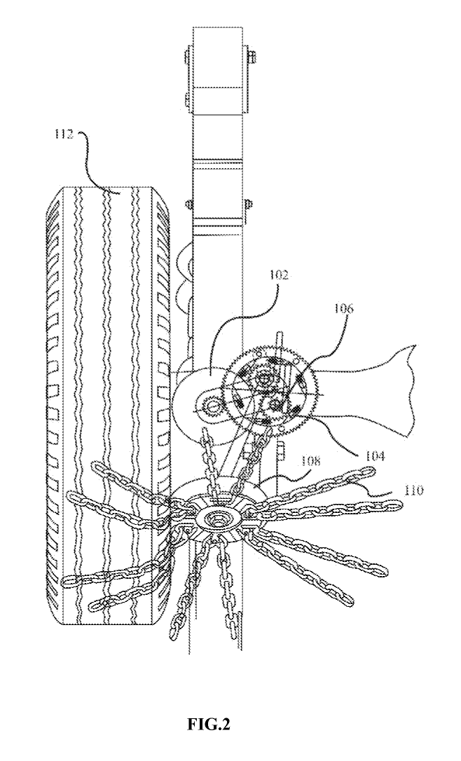

FIG. 2 illustrates a side perspective view of the automatic tire chain system with the plurality of chains in an open mode according to one embodiment. With respect to FIG. 2, the plurality of chains 110 in the automatic tire chain system is in the open form. When the driver presses the button, the pin is pulled inwards the main cog wheel and releases the plurality of chains 110 of the automatic tire chain system. The chain works under the tires 112 until the driver pushes the button and the first cog wheel 102 comes in contact with the tires 112 and the circular force is transferred from the tires 112 to the main cog wheel 104 through the first cog wheel 102. The circular force is then transferred to the small cog wheel 106 and the arm cog wheel 108 which in turn causes the plurality of chains 110 to open and rotate horizontally along with the tires 112. After the plurality of chains 110 comes in contact with the tires 112, the pin of the electromagnetic motor enters the hole of the main cogwheel 104 and the system is locked. Further the vehicle moves along with the chain hugged to the tires 112. The system is designed for unlocking the chain 110 from the tires 112. The unlocking includes accumulating the plurality of chains 110 that are stuck to the tires 112.

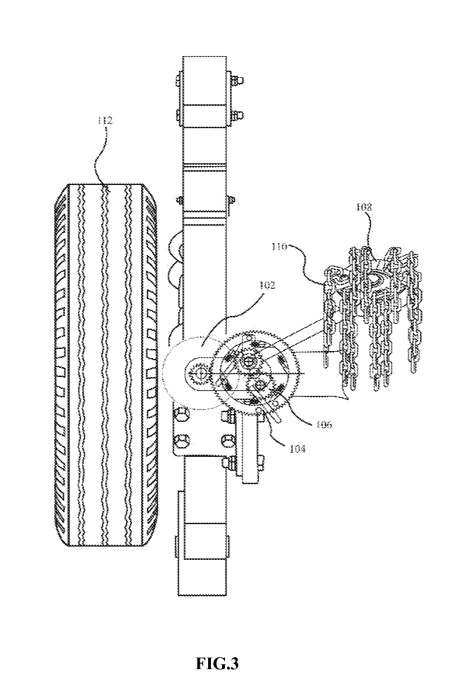

FIG. 3 illustrates a side perspective view of the automatic tire chain system with the plurality of chains accumulated according to one embodiment. With respect to FIG. 3, the pluralities of chains 110 in the automatic tire chain system are in an accumulated mode. The button is released to get the plurality of chains 110 of the automatic tire chain system in the accumulated form. The releasing operation of the button provides for transferring the circular force directly to the main cog wheel 104 from the tires 112. The main cog wheel 104 then transfers the circular force to the arm cog wheel 108 and rotates the arm of the wheel at an angle of 180° which in turn causes the plurality of chains to get accumulated automatically.

Initially the plurality of chains 110 in the automatic tire chain system is in the accumulated form. Further in the accumulated form, the pin of the electromagnetic motor enters the hole of the main cogwheel 104, and the chains are separated from the tires 112. The plurality of chains 110 in the automatic tire chain system remains in the locked form until the driver presses the button. The automatic tire chain system remains in the locked form and the mechanical force caused by the movement of the vehicle in rough roads has no influence on the functionality of the tire chain system until the driver presses the button.

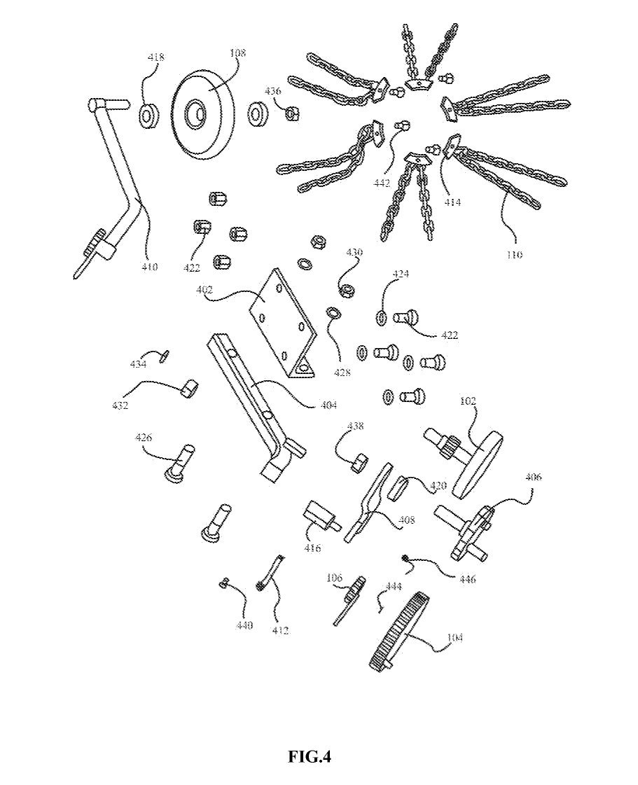

FIG. 4 illustrates an exploded view of the automatic tire chain system according to one embodiment. The exploded view of the automatic tire chain system includes a clamp plain 402, a slide 404, a fix shaft 406, a tumbler arm 408, an arm 410, a spring U shape 412, a chain clamp plain 414, an electromagnet 416, a first ball bearing 418, a second ball bearing 420, a first hexagon nut 422, a spring washer 424, a hexagon screw 426, a spring washer 428, a second hexagon nut 430, a third hexagon nut 432, a spring washer 434, a fourth hexagon nut 436, a fifth hexagon nut 438, a first cylinder head cap screw 440, a second cylinder head cap screw 442, a spring retaining ring 444, and a compression spring 446.

The clamp plain 402 is adapted to install the automatic tire chain system in the vehicles. The slide 404 is used to stabilize and maintain the fix shaft 406. The fix shaft 406 forms the circular axis for the tumbler arm 408, the arm 410 and the small cog wheel 106. The first cog wheel 102 and the electromagnet 416 are connected to the tumbler arm 408 and the first cog wheel 102 is provided to have circular movements around the axis. The first cog wheel 102 transfers the circular force from the tire to the main cog wheel 104 and the main cog wheel 104 transfers the circular force to the arm cog wheel 108 and the small cog wheel 106 which in turn causes the plurality of chains 110 either to open or get accumulated automatically.

The arm cog wheel 108 maintains the plurality of chains 110 connected to it and rotates them around the circular axis when having contact with the tire. Further when the mechanism is locked, the spring U shape 412 is pressed due to which the tumbler arm 408 is brought to an initial condition and makes the first cog wheel 102 to come in contact with the tires 112. The chain clamp plain 414 is used to connect the plurality of chains 110 to the arm cog wheel 108. The compression spring 446 along with the spring retaining ring 444 causes the circulation force for the main gear wheel 104 in one direction.

The electromagnet 416 is used to set the mechanism free and also to lock after opening or accumulating the tire chains 110. The ball bearing 418 creates the possibility of circulation around the circular axis of the arm cog wheel 108 and the ball bearing 420 creates the possibility of circulation of the first cog wheel 102 around the circular axis. The spring washer 434 is used to prevent the fix shaft 406 to be opened. The spring retaining ring 434 is used to prevent the arm 410 and the small gear wheel 106 to get out of line.

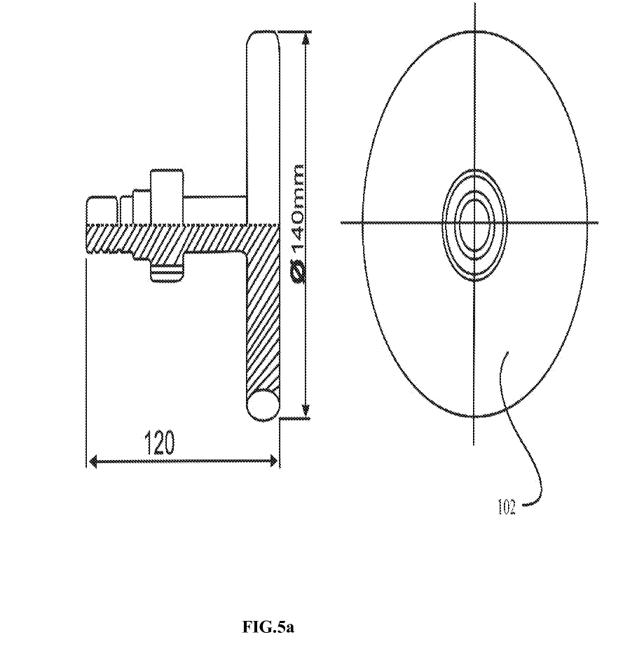

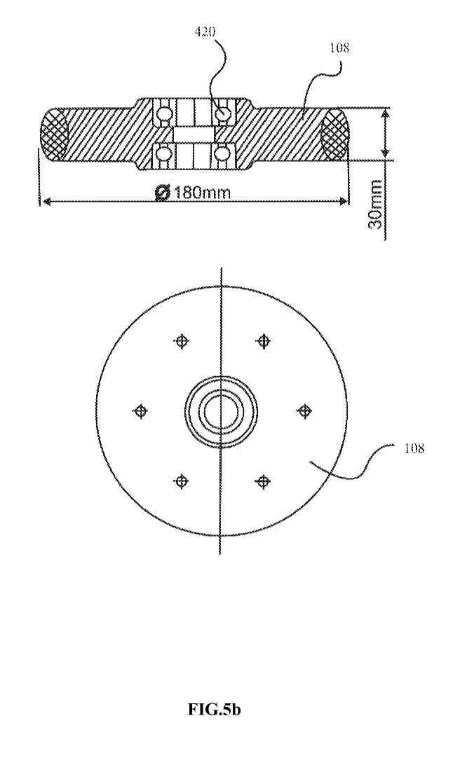

FIG. 5a-5b illustrates a front side perspective view of the first cog wheel and the arm cog wheel in the automatic tire chain system according to one embodiment. With respect to FIG. 5a, the automatic tire chain system includes the first cog wheel 102 for transferring the circular force from the tires to the main cog wheel. The first cog wheel 102 is arranged along the circular axis of the arm to transfer the circular force to the main cogwheel. When the mechanism in the automatic tire chain system is set free then the first cog wheel 102 gets the circular force from the car wheel and transfers the circular force to the main cogwheel and it rotates around along the circular axis on the main arm. Further when the mechanism rotates around the main cogwheel, the plurality of chains moves away from the tires and the flow of force to the automatic tire chain system are interrupted.

While with respect to FIG. 5b, the arm cog wheel 108 is located on a stable axis and can rotate around its own circular axis half a round when the plurality of chains is in either opened or accumulated form. The plurality of chains sticks to the tires when the automatic tire chain system is in the opened form and rotates around the circular axis of the tires. Further a bearing exists between the axis of the arm and the tire chain due to which the plurality of chains are thrown under the tires.

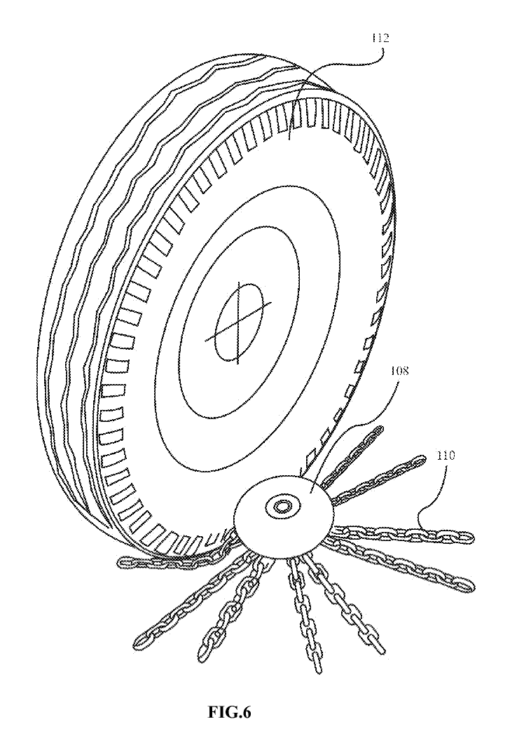

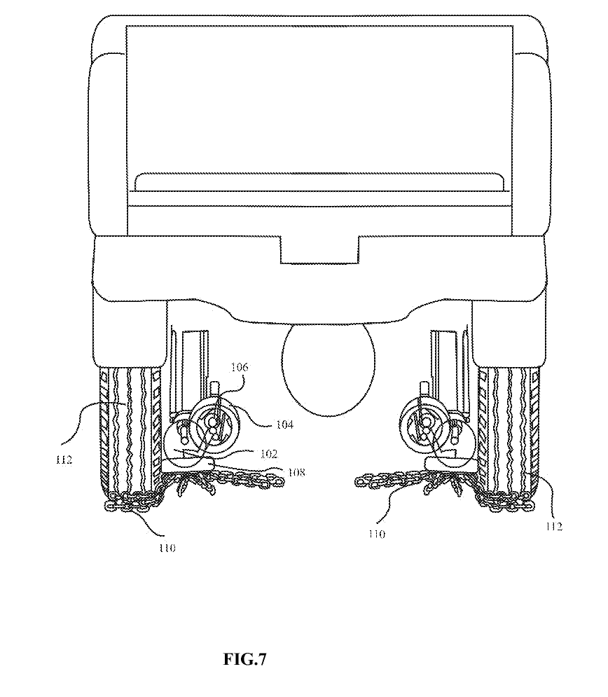

FIG. 6 illustrates a side perspective view of the automatic tire chain system with the plurality of chains opened over the tires according to one embodiment. FIG. 7 illustrates a side perspective view of the automatic tire chain system with the plurality of chains opened over the tires according to another embodiment. While with respect to FIG. 6 and FIG. 7, the automatic tire chain system is installed in the vehicles. The plurality of chains are connected on the arm cog wheel 108 through one or more pins and the plurality of chains 110 stick to the tires 112 when the automatic tire chain system is in the opened form and rotates around the circular axis of the tires 112.

The chains 110 are thrown under the tires 112 using the centrifugal force and the chains 110 are located between the wheel and the road level. Further mass balancing of the wheels is also achieved by installing the tire chain system under the vehicles. Consider an example, a car is 1700 K and the automatic tire chain system installed is 20 K, therefore the weight of the car increases by 1.18%. Further by installing the tire chain system the gravity center of the car moves backwards and the balance is maintained as show in FIG. 7.

When the plurality of chains is either opened or accumulated, the hole of the main cogwheel 104 reaches the pin of the electromagnetic motor and the spring inside the electromagnetic motor causes the pin to enter the hole of the main cogwheel 104. Further the middle arm and the main cogwheel 104 are locked together. The circular force applied to the first cog wheel 102 in turn rotates the mediator arm around the main cogwheel 104 and the flow of transferring circular force to the mechanism is stopped.

The automatic tire chain system described herein provides for installing the tire chain system, when the vehicle moves on the snowy roads without requiring a stop of the car. The single button operation provides for the opening of the plurality of the chains when the vehicle travels along snowy roads and accumulating of the plurality of chains automatically with minimum amount of time and energy. The mass balance of the wheels is also maintained since the plurality of chains is under the tires. Further the mechanism used in the automatic tire chain system possesses high safety and by changing the dimension, the automatic tire chain system can be installed on a variety of vehicles.

The mechanism used in automatic tire chain system is automatic and the balancing of wheels is achieved in high speeds. Further when the chains is in the open condition, the chain sticks to the tire horizontally and rotates along with it by throwing the chain under the tires using the centrifugal force and the chains are located between the wheel and the road level.

The foregoing description of the embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. An automatic tire chain system consisting:
a first cog wheel;
a main cogwheel;
a small cog wheel;
an arm cog wheel;
a plurality of chains connected to the arm cog wheel;
an electromagnetic motor;
an arm for interconnecting the first cog wheel and the main cog wheel; and
a button;
Wherein the button is pressed to transfer a circular force from a wheel of a vehicle to the arm cog wheel which in turn causes the plurality of chains to get opened to embrace the tire or detach from the tire to get accumulated.

2. The automatic tire chain system of claim 1, wherein the circular force from the wheel of the vehicle is transferred to the main cog wheel through the first cog wheel and the main cog wheel transfers the circular force to the small cog wheel and the arm cog wheel.

3. The automatic tire chain system of claim 1, wherein the first cog wheel is arranged along a circular axis of the arm to transfer the circular force to the main cogwheel.

4. The automatic tire chain system of claim 1, wherein the first cog wheel rotates around the main cog wheel when the plurality of chains are in the accumulated state.

5. The automatic tire chain system of claim 1, further comprises:
a tumbler arm;
a spring; and
at least one pin.

6. The automatic tire chain system of claim 5, wherein the pin connects the plurality of chains to the first cog wheel.

7. The automatic tire chain system of claim 1, wherein the button is pressed to stimulate the electromagnetic motor which in turn causes the pin to exit the main cogwheel.

8. The automatic tire chain system of claim 1, further comprising a clamp pin to install the plurality of chains in the vehicle.

9. The automatic tire chain system of claim 1, wherein the main cog wheel comprises the pin to operate the electromagnetic motor during the plurality of chains functioning.

10. The automatic tire chain system of claim 9, wherein the plurality of chains functioning includes either opening or accumulating of the plurality of chains.

11. The automatic tire chain system of claim 1, wherein the arm cog wheel is located on a stable axis and is adapted to rotate half a round on a circular axis of the arm cog wheel when the plurality of chains is either opened or accumulated.

12. The automatic tire chain system of claim 1, wherein the small cog wheel is located on the stable axis and is adapted to rotate half a round on the circular axis of the arm cog wheel when the plurality of chains is either opened or accumulated.

13. The automatic tire chain system of claim 1, wherein the circular force is transferred to the main cogwheel from the wheel of the vehicle when the plurality of chains are in a free state and the flow of force to the plurality of chains is interrupted.

14. The automatic tire chain system of claim 1, further comprising a bearing between the arm and the plurality of chains to provide the plurality of chains under the tires.

15. The automatic tire chain system of claim 1, wherein the plurality of chains sticks to the tire and rotates around the circular axis by throwing the plurality of tire chains under the tires due to a centrifugal force.

16. The automatic tire chain system of claim 1, wherein the first cog wheel rotates in a clockwise direction when the plurality of chains are opened.

17. The automatic tire chain system of claim 1, wherein the main cogwheel and the small cog wheel is rotated in an anti-clockwise direction which in turn causes the arm cog wheel to rotate in a clockwise direction when the plurality of tire chains are opened.

18. The automatic tire chain system of claim 1, wherein the button is released to stop a movement of the plurality of chains.
